(19) United States
(12) Patent Application Publication
(10) Pub. No.: US 2012/0263837 A1
(43) Pub. Date: Oct. 18, 2012

(54) FEED SUPPLEMENT AND METHOD

(76) Inventors: Graeme Douglas Coles, Amberley (NZ); Robert John Pearce, Kiama (AU)

(21) Appl. No.: 13/518,935

(22) PCT Filed: Dec. 22, 2010
(86) PCT No.: PCT/IB2010/056039

§ 371 Date: Jun. 25, 2012

(30) Foreign Application Priority Data
Jan. 20, 2010 (NZ) 582746

(51) Int. Cl. A23K 1/06

(52) U.S. Cl. 426/231; 426/624; 426/271; 426/465; 426/473; 426/454

(57) ABSTRACT

A process for preparing at least one animal feed supplement from one or more distillation by-product which includes the following steps in order: A Prepare the or each distillation by-product for processing; B Mix a prepared distillation by-product with one or more cation source; C Dry one or more reaction product; such that step A results in the prepared distillation by-product ready for step B and step B produces the one or more reaction product for step C.

### TECHNICAL FIELD

The present invention is a feed supplement and/or methods for manufacturing it.

### BACKGROUND ART

With many animals being reared in areas with natural feed of low or unbalanced quality available it is often necessary to augment diets with additional high quality feed and/or supplements. Many of these supplements/feeds are liquids.

Liquid supplements/feeds often have a high transportation cost due to their water content. This can make them too expensive when compared against similar dry products so this limits their use. In addition, at low temperatures the viscosity of liquid supplements/feeds increases; this means that storage tanks, pumps and valves need to be insulated in colder climates. This can also make liquid supplements/feeds expensive to use.

It is known in animal nutrition, especially for intensively reared monogastrics, to use mixtures of organic acids to lower the pH of the digesta. This lowering of the pH has been found to reduce or eliminate the need for antibiotics as prophylactics against gut pathogens. These mixtures are formulated from pure precursors which are expensive, thus limiting their use commercially.

There is an increasing use of ethanol by-products as feed or feed supplements, generally in the form of Distillers Dried Grains (DDG) or Distillers Dried Grain and Solubles (DDGS). To produce each of these by-products the material remaining after the distillation process (Whole Stillage) is centrifuged to produce crude solids and thin stillage. Thin stillage is an aqueous suspension of yeast components, soluble non-fermentation products and fermentation by-products.

The thin stillage is evaporated to form Condensed Distillers Solubles (CDS), CDS is sometimes called ‘Distillers Syrup’, ‘Distillers Concentrated Syrup’ or ‘Condensed Distillers Solubles’ sometimes shortened to DCS. For consistency we will use Condensed Distillers Syrup or CDS. The CDS is sold separately or combined with the coarse solids (sometimes referred to as crude solids) to form Wet Distillers Grains and Solubles (WDGS). The WDGS is dried to form DDGS. If the coarse solids are dried without the CDS being added the product is DDG.

The CDS is high in organic acids (mainly lactic acid), unfermented carbohydrates and yeast breakdown products (including protein and polar lipids). This makes it useful as a supplement/feed and it has to a limited extent been used as a feed supplement for low quality forage diets. Some of the problems associated with CDS which limit the use of CDS as a supplement/feed on its own include susceptibility to bacterial fermentation, separation in storage tanks and the increase in viscosity at low temperatures. These problems can be overcome by quick delivery to the end user, incorporating some form of mixing device in the storage tank and insulating the feed delivery system (storage tank, pumps and lines), but this comes at a cost. A second, less tractable problem is that CDS cannot be dehydrated to a solid this creates handling and dosage control challenges. For these reasons and others most of the CDS is combined to form WDGS, then dried to form DDGS.

Any discussion of the prior art throughout the specification is not an admission that such prior art is widely known or forms part of the common general knowledge in the field.

It would be advantageous if the present invention could overcome one or more of the problems mentioned earlier.

### Disclosure of Invention

The present invention provides a process for preparing at least one animal feed supplement from one or more distillation by-product which includes the following steps in order:

A Prepare the or each distillation by-product for processing;

B Mix a prepared distillation by-product with one or more cation source;

C Dry the or each reaction product;

such that step A results in the prepared distillation by-product ready for step B and step B produces the one or more reaction product for step C.

Preferably the or each cation source contains one or more cation.

Preferably the distillation by-product used is thin stillage and/or condensed distillers solubles. In a highly preferred form the thin stillage is evaporated to about 60% water content in step A. Preferably the evaporated thin stillage is not cooled before step B.

In a highly preferred form the or each cation is capable of forming one or more complex or chelate with at least one of the constituents in the distillation by-product. In a preferred form the constituent is a reactive organic acid. Preferably the reactive organic acid is lactic or acetic acid.

Preferably, in one form, essentially all of the organic acids present are reacted in step B.

Preferably Step A is determining the water content and/or organic acid content of the or each distillation by-product and/or adjusting the water content and/or organic acid content to the required level. In a highly preferred form the desired water content is between 40% and 75%.

Preferably in step B the or each cation is independently chosen from Mg, Ca, Fe, Cu, Co, Mn, Zn or Mo. In a highly preferred form the or each cation is added as a carbonate, oxide, bicarbonate, hydroxide, chloride, sulphate, nitrate or phosphate.

In a preferred form the cation source is a natural mineral such as dolomite, limestone or magnesite. In a further preferred form the cation source is milled to a powder before addition to the prepared distillation by-product.

It is preferred that the vessel in which the reaction occurs allows any resultant gases to be removed. Preferably the reaction in step B occurs with minimal loss of heat from the reaction vessel.

Preferably, if the reaction vessel used does not allow degassing an additional step D is carried out to degas the reaction product before drying.

Preferably the reaction product from step B is a paste that is transferred to a drying device for step C with minimal heat loss.

Preferably the dried reaction product from step C is in the form of a powder.

Preferably the drying device used for step C is a cyclonic drying mill. Preferably if the drying is carried out in a drying device that does not reduce the dried reaction product's particle size, an additional step E is carried out to reduce the particle size to the desired range.

Preferably, the reaction products of desired particle size are then pelletised

The present invention also includes an animal feed supplement, or reaction product produced by the above method. Preferably the reaction product can be separated into one or more independent animal feed supplements.

### BRIEF DESCRIPTION OF DRAWINGS

By way of example only, a preferred embodiment of the present invention is described in detail below with reference to the accompanying drawings, in which:

FIG. 1 is a flowchart of the key steps in the process;

FIG. 2 is a flowchart showing an optional process step;

FIG. 3 is a flowchart showing an optional process step.

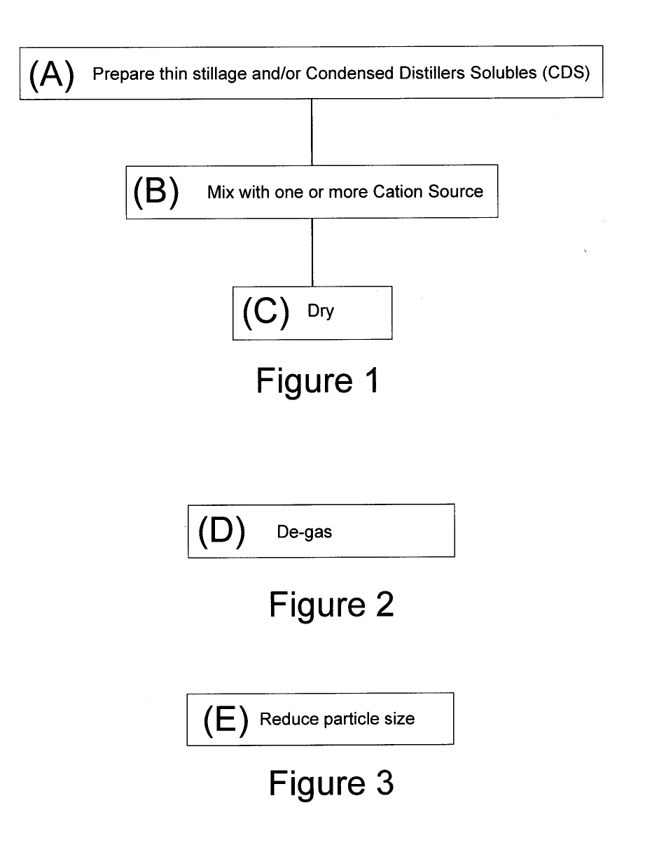

### BEST MODE FOR CARRYING OUT THE INVENTION

Referring to the drawings a process for preparing an animal feed supplement is shown which includes the following steps in order:
A. Prepare thin Stillage and/or Condensed Distillers Solubles (CDS);
B. Mix the thin stillage and/or CDS with one or more Cation Source;
C. Drying.

In step A Thin Stillage and/or Condensed Distillers Solubles (CDS) are prepared for the next step in the process. If thin stillage is used then this step can include an evaporation step to reduce the water content to a suitable level. Once the thin stillage and/or CDS is in a suitable form then the concentration of one or more of the reactive organic acids present is determined. Part of the preparation process may include storing the thin stillage and/or Condensed Distillers Solubles (CDS) in this form for a time then re-determining the concentration of one or more of the reactive organic acids present as it has been found the lactic acid and acetic acid concentrations generally increase with storage. It should be noted that the term ‘reactive organic acid’ is intended to cover lactic acid, acetic acid and other organic acids that form complexes or chelates with cations.

The reactive organic acid concentration is used to determine the maximum amount of cation source required in step B. It is not necessary for all the reactive acid to be slaked by cation. In many applications, it will be desirable to leave a proportion of reactive organic acid to better provide for digesta pH reduction. It should be noted that the sodium:potassium ratio in thin stillage and/or CDS is appropriate for animal nutrition so no adjustments to this are normally needed, but additional material may be added at this stage to optimise the final product for a specific use.

The reactive organic acid of most interest at present is lactic acid, as it is well known that lactic acid forms complexes or chelates with cations capable of entering an oxidation state of II or higher. These lactic acid/lactate complexes or chelates, where the cation is Mg, Ca, Fe, Cu, Co, Mn, Zn or Mo, are known to make these cations far more bioavailable than inorganic salts of the same cations. It is believed that this process forms compounds of the mentioned cations in, at least partially, lactic acid/lactate complexes or chelates.

In step B the prepared thin stillage and/or CDS from step A is mixed with the predetermined amount of the cation source. It is envisioned that the cation sources used will be natural minerals such as limestone, dolomite, magnesite for example. However, oxides, carbonates, hydroxides, chlorides, sulphates, nitrates, etc, of natural or artificial origin, of the cations could also be used as a cation source. If natural minerals are used they need to be of sufficiently high quality to minimise any contamination of the final product.

The cation source needs to be in a form that will react with the prepared thin stillage and/or CDS from step A. For example a fine powder or sand may be used. Alternatively the cation source may be dissolved in liquid (water for example) and added to the prepared Thin Stillage and/or CDS. The processing continues until the reaction is as complete as required. The cessation of gas evolution or a specific pH of the reaction mixture can be used to determine the reaction endpoint required.

If the reaction in step B involves gas production e.g. from a carbonate, then the vessel used for the processing needs to be designed to allow the resultant foam to degas. Alternatively an additional degassing step D can be carried out on the resulting product before step C.

If the cation is Calcium then the reaction with the lactic acid present is exothermic, and it forms a hydrated precipitate (Ca²⁺ (CH₃CHOCOOH)⁻₂≈5H₂O). This exothermic reaction and precipitate formation reduces the amount of energy needed for step C.

In step C the product is dried by known means, e.g. dry air, microwave, cyclonic drying, oven drying, etc. The heat from the exothermic reactions and the binding of the water of hydration into precipitates, complexes and chelates significantly reduces the amount of energy used for drying. The drying can be carried out by any known means, cyclone, fluid bed, microwave, infra-red, etc or a combination of these.

Optionally, as shown in step E, the dried material is milled to form a finely divided powder for packaging and distribution. This step may not be necessary if the product from step C is in the form desired. Alternatively, the dried material may be pelletised for ease of transport in subsequent processing. This material provides minerals, trace elements, protein, lipids, digestible polysaccharides, fibre and/or a product useful for reducing the animals digesta pH.

In further embodiments micro-nutrients can be added at any stage to specifically treat an identified deficiency symptom in target animals.

In a further embodiment the reaction product produced in step B is not dried but directly used as a paste. This paste could be diluted to form a liquid or mixed with dry materials to form an alternative feed or feed supplement.

In any embodiment the cation source may contain more than one cation, and be in one or more form. In fact if the cation source is a natural product such as dolomite this is almost certain to be the case.

In one embodiment the dried material is separated into one or more separate feed supplement prior to milling or pelletising (for example) for shipment as independent products.

For some embodiments of the process step B may be repeated with a number of different cation sources prior to step C being undertaken.

In further embodiments, where step B involves gas production e.g. from a carbonate, then the drying equipment is designed or operated to allow the removal of any gaseous reaction products.

It should be noted that although the specific embodiment and examples concentrate on grain ethanol distillation by-products, ethanol distillation from grapes or other sources is also envisaged. The by-product need only have a sufficient organic acid content to allow the formation of a reaction product which can be dried are also suitable.

### SPECIFIC EXAMPLES

### Example 1

Thin stillage from ethanol production is concentrated by evaporation until the water content is about 60%, i.e. the thin stillage is processed to form Condensed Distillers Solubles. The content of lactic and acetic acid is determined, and the required amount of limestone, dolomite and/or magnesite is added to the hot/warm evaporated thin stillage. The following reactions are believed to occur:

βCO₃+2CH₃CHCOHCOOH+4H₂O→(CH₃CHOHCOO)₂β.5H2O+CO₂

and

βCO₃+2CH₃COOH+(x−1)H₂O→(CH₃CHOHCOO)₂β.xH2O+CO₂

where β is Calcium or Magnesium

These reactions are allowed to go through to completion in a vessel designed to allow the CO₂ released to escape without excessive foaming. The reactions are exothermic, and the residual evaporation heat is retained as much as possible as the resultant paste product is transferred to a cyclonic drying mill. The paste is dried to a moisture content of less than 10% and a particle size of less than 100 μm. The drying is carried out at a temperature sufficiently low as to minimise or prevent protein cross-linking and browning. The actual drying temperature is determined by experiment but is not likely to exceed much more than about 80° C. Brief exposure to high temperatures may be necessary to reduce pathogen loading of the final product but this is not part of the drying process.

### Example 2

The process in example 1 is carried out using a magnesium mineral source to create a product used as a supplement for dairy cattle, at a dose rate of 10 g/cow/day of digestible magnesium.

### Example 3

Dolomite is used in the process described in example 1 to produce a product used to reduce the duodenal digesta pH in pigs by 0.5.

### Example 4

A calcium-rich product is used to provide an accessible calcium source for poultry to maintain bone reserves during lay. A proportion of the cation reactant is supplied as the phosphate so as to ensure the calcium:phosphorus ratio of the final product is appropriate. The dose rate is determined by the potassium:sodium ratio in the product.

### Example 5

Five kilograms of Condensed Distillers Syrup (CDS) was obtained from a commercial production source. The water content of the CDS was determined by drying a 10 ml sample to constant weight in an oven at 105° C. The water content of the CDS was found to be 60%. At constant weight the dried CDS became a sticky, rubbery mass.

The CDS (from the manufacturer's analysis) included 27% lactic acid, and 3% acetic acid. The lactic acid and acetic acid figures were used to determine the amount of magnesium carbonate required to react with the quantity of organic acids present. This was determined to be 505 g of Magnesium Carbonate (MgCO₃). The 5 litres of DCS was heated to 75° C. and the 505 g of Magnesium Carbonate was weighed out and then slowly added to the DCS with vigorous stirring. During addition of MgCO₃, gas evolution was observed as expected, and the pH of the DCS/MgCO₃ mixture rose steadily from 4.1 to 7. As the last of the quantity of MgCO₃ calculated to be needed for complete reaction was added, the rate of pH increase slowed, as did gas evolution.

The resultant reaction mixture was cooled to room temperature, and a sample was taken for water content determination. The remaining reaction mixture was then spread onto metal trays and frozen, before freeze-drying.

The water content of the reaction mixture was determined to be 50%, as expected from the addition of solid MgCO₃, and the known acquisition of water of hydration by magnesium lactate and magnesium acetate.

Once the bulk of the reaction mixture was fully freeze-dried, it was easily crumbled to a dry, readily-flowing powder. Much easier to handle than the sticky, rubbery mass obtained from simply drying the CDS.

A similar process was carried using CaCO₃, and apart from a slight fall in reaction mixture water content, consistent with the increased atomic weight of Ca compared with Mg, similar results were obtained.

### Example 6

One cubic meter of CDS was obtained from the manufacturer. The analysis was similar to the CDS used for Example 5.

Seventy five litres of CDS was placed in a jacketed, stirred Cleveland kettle and heated to 75° C. As in Example 5 the quantity of MgCO₃ required was estimated from the content of organic acids claimed by the manufacturer, and found to be 7.6 kg. This quantity was added and found to cause the pH to rise from 4.1 to 7.0 as expected. Stirring continued until all the gas evolved was released from the very viscous liquid. It was clear that on this larger scale, pH was a more reliable indicator than gas evolution that reaction had ceased.

A sample of reaction mixture was tested for water content, and this was found to be 51.3%.

A one-litre sample of the reaction mixture was taken for drying using a small-scale cyclone drying mill. To avoid nozzle blockages, the product was diluted to a final water content of 80% prior to drying. A small quantity of dry, flowable finely divided powder was obtained.

Nutritional Analysis—DCS and Mg Products Produced in Example 5 and/or 6

In vitro nutritional analysis comparing DCS and the dried magnesium reaction product determined that the protein content and in vitro ME values declined by no more than would be expected from the additional magnesium content. This was a surprising result.

Palatability of Reaction Products from Example 5 and/or 6

Background:

Magnesium supplements generally suffer from a lack of palatability, as magnesium salts are bitter, and MgO, which is often applied to pasture or forage supplements as a finely divided dust, is known to reduce feed acceptability.

To determine if the magnesium reaction product had the same palatability problem samples were evaluated for palatability in several companion and production species.

In all cases, the product tested was prepared as described in example 5 above.

Domestic short-haired cats: Two well-fed domestic pet cats, one a young neutered male, the other an older neutered female, were offered 5 g of the dried Mg reaction product alongside a normal-sized meal of fresh fish at room temperature. The young male consumed the dried Mg reaction product with avidity prior to eating the fish. The older female, whose appetite is normally relatively limited, consumed the dried Mg reaction product and the fish concurrently and completely. Both animals now view a small quantity of dried Mg reaction product as a treat to be sought regularly.

Dogs: A neutered female Jack Russell terrier regularly consumes 10 g portions of toasted bread with butter and yeast extract, but will not readily eat toasted bread by itself. Toasted bread was spread with a mixture of 50% dried Mg reaction product with cold water and offered to this dog. A total of 50 g of toasted bread with 25 g of dried Mg reaction product solids was prepared and offered in portions of approximately 10 g. All were consumed with avidity.

Breeder hens: A small flock (5 hens and one cockerel) was offered a meal of 250 g of layer mash mixed with 50 g of dried Mg reaction product. All the mixture was immediately consumed with no apparent problems.

In addition, small samples have been offered to goats, calves, and lambs, all of which immediately consumed the product. So surprisingly the magnesium addition does not appear to have affected the palatability or nutritional value of the CDS.

1. A process for preparing at least one animal feed supplement from one or more distillation by-product which includes the following steps in order:
A prepare the or each distillation by-product for processing;
B react a prepared distillation by-product with one or more cation source to form at least one reaction product in the form of a hydrated precipitate and where at least one cation in said cation source is not monovalent;
such that step A results in the prepared distillation by-product ready for step B, wherein said prepared distillation by-product includes at least one organic acid.

2. (canceled)

3. The process as claimed in claim 1 characterised in that the organic acid is lactic or acetic acid.

4. The process as claimed in claim 1 characterised in that Step A is, or includes, determining the water content and/or organic acid content of the or each distillation by-product prior to step B.

5. The process as claimed in claim 1 characterised in that the or each cation source contains one or more cation.

6. The process as claimed in claim 1 characterised in that the or each cation is capable of forming one or more complex or chelate with at least one of the constituents in at least one distillation by-product.

7. The process as claimed in claim 1 characterised in that essentially all of the organic acid(s) present are reacted in step B.

8. The process as claimed in claim 1 characterised in that the distillation by-product used is thin stillage and/or condensed distillers solubles.

9. The process as claimed in claim 1 characterised in that at least one of the distillation by-products used in step A is thin stillage.

10. The process as claimed in claim 9 characterised in that the thin stillage is evaporated to about 50% to 60% water content in step A.

11. The process as claimed in claim 10 characterised in that the evaporated thin stillage is not cooled before step B.

12. The process as claimed claim 1 characterised in that in step B the or each cation is independently chosen from Mg, Ca, Fe, Cu, Co, Mn, Zn or Mo.

13. The process as claimed in claim 1 characterised in that the or each cation is added as a carbonate, oxide, bicarbonate, hydroxide, chloride, Sulphate, Nitrate or Phosphate.

14. The process as claimed in claim 1 characterised in that the cation source is a natural mineral such as dolomite, limestone or magnesite.

15. The process as claimed in claim 1 characterised in that the cation source is milled to a powder before addition to the prepared distillation by-product in step B.

16. The process as claimed in claim 1 characterised in that the process is carried out in a vessel which the reaction occurs allows any resultant gases to be removed.

17. The process as claimed in claim 1 characterised in that the process is carried out in a vessel which does not allow degassing, wherein a step D is carried out, such that step D is carried out to degas the reaction product after step B.

18. The process as claimed in claim 1 characterised in that the reaction in step B occurs with minimal loss of heat from the reaction vessel.

19. The process as claimed in claim 27 characterised in that the reaction product from step B is a paste that is transferred to a drying device for step C with minimal heat loss.

20. The process as claimed in claim 27 characterised in that the dried reaction product from step C is in the form of a powder.

21. The process as claimed in claim 19 characterised in that the drying device used for step C is a cyclonic drying mill.

22. The process as claimed in claim 27 characterised in that if the drying is carried out in a drying device that does not reduce the dried reaction product's particle size to a desired range, an additional step E is carried out to reduce the particle size to the desired range.

23. The process as claimed in claim 22 characterised in that the reaction products of desired particle size are then pelletised.

24. The process as claimed in claim 1 characterised in that the reaction product can be separated into one or more independent animal feed supplements.

25. An animal feed supplement, or reaction product produced by the process as claimed in claim 1.

26. A combination of one or more reaction product or animal feed supplement produced by the process as claimed in claim 1.

27. The process as claimed in claim 1 characterised in that the process includes a step C which follows step B, where step C is:
C dry one or more reaction product.
